(19) United States
(12) Patent Application Publication
(10) Pub. No.: US 2012/0002248 A1
(43) Pub. Date: Jan. 5, 2012

(54) LIGHT EMITTING DEVICE AND IMAGE SCANNING APPARATUS

(75) Inventors: Koji SHIMOKAWA, Shizouka-ken (JP); Yusuke Hashizume, Chiba-ken (JP); Hiroyuki Shiraishi, Shizuoka-ken (JP); Naoya Koseki, Shizuoka-ken (JP); Katsuya Nagamochi, Tokyo (JP); Mitsuru Hatano, Kanagawa-ken (JP); Sueo Ueno, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/175,057

(22) Filed: Jul. 1, 2011

Related U.S. Application Data
(60) Provisional application No. 61/361,356, filed on Jul. 2, 2010.

(51) Int. Cl. H04N 1/04; H05B 37/02

(52) U.S. Cl. 358/475; 315/308; 315/151

(57) ABSTRACT

There is a light emitting device including a light source which generates light and of which the quantity of light emission changes according to a driving current, a driving circuit which runs the driving current to the light source to drive the light source, and a controller which controls the driving circuit and raises the driving current of the light source as the quantity of light emission from the light source decreases.

### CROSS-REFERENCE TO RELATED APPLICATION

This application is based upon and claims the benefit of priority from: U.S. provisional application 61/361,356, filed on Jul. 2, 2010, the entire contents of which are incorporated herein by reference.

### FIELD

The Embodiments described herein relate generally to a light emitting device and an image scanning apparatus.

### BACKGROUND

An image scanning apparatus radiates light onto a document, and senses light reflected on the document to generate image data corresponding to the document. Such an image scanning apparatus includes a light source generating light to be radiated onto a document.

The quantity of light emission from a light source may be lowered as time passes. If the quantity of light emission from a light source is lowered, the brightness of a document illuminated by the light source changes.

### DESCRIPTION OF THE DRAWINGS

FIG. 1 is a diagram showing the internal configuration of an image forming apparatus.

FIG. 2 is a diagram showing the internal configuration of the image scanning apparatus.

FIG. 3 is a schematic diagram showing a configuration of a circuit driving an illuminating device as a first embodiment.

FIG. 4 is a graph showing changes of the quantity of light emission from an LED and changes of a driving current of the LED.

FIG. 5 is a graph showing changes of the quantity of light emission from the LED when driving of the LED is started.

FIG. 6 is a flowchart showing driving control of the LED according to the first embodiment.

FIG. 7 is a schematic diagram showing a configuration of a circuit driving an illuminating device as a second embodiment.

FIG. 8 is a flowchart showing driving control of an LED according to the second embodiment.

### DETAILED DESCRIPTION

According to an embodiment, a light emitting device includes a light source which generates light and of which the quantity of light emission changes according to driving currents, a driving circuit which causes the driving current to flow to the light source to drive the light source, and a controller which controls the driving circuit and raises the driving current of the light source as the quantity of light emission from the light source is lowered.

### First Embodiment

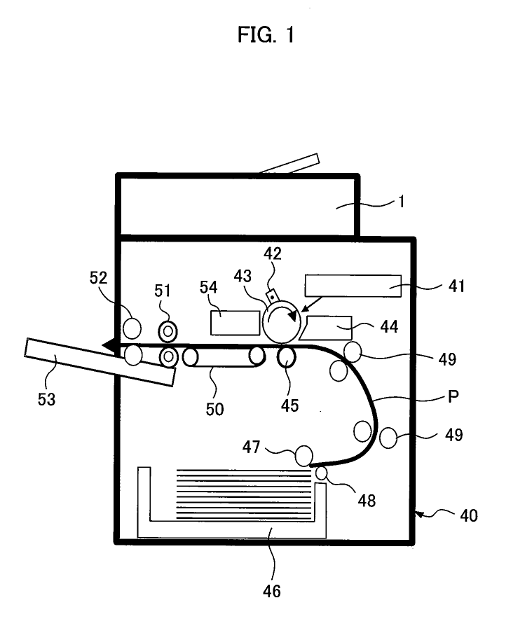

An image forming apparatus (or MFP: Multi-Function Peripheral) according to the present embodiment will be described with reference to FIG. 1. FIG. 1 is a schematic diagram showing the internal configuration of an image forming apparatus 40.

The image forming apparatus 40 includes a paper feeding cassette 46, and the paper feeding cassette 46 accommodates a plurality of sheets. A paper feeding roller 47 and a separation roller 48 separate the plurality of sheets accommodated in the paper feeding cassette 46 one by one to supply the sheets to a sheet transporting passage P. The sheet transporting passage P includes a plurality of transporting rollers 49. An image is formed on a sheet while the sheet passes through the sheet transporting passage P.

A charging device 42 charges a surface of a photosensitive drum 43. The photosensitive drum 43 rotates in a direction indicated by a arrow. An optical scanner 41 forms an electrostatic latent image corresponding to image data on a photosensitive surface of the photosensitive drum 43 by irradiating the photosensitive surface with a laser beam. The image data includes, for example, image data transmitted to the image forming apparatus 40 from an external device (for example, a personal computer), or image data generated by a reading operation of an image scanning apparatus 1.

A development device 44 forms a toner image by supplying toner on the surface of the photosensitive drum 43. A transfer device 45 transfers the toner image formed on the surface of the photosensitive drum 43 onto a sheet. A cleaning device 54 removes toner remaining on the surface of the photosensitive drum 43.

In the embodiment, the toner image formed on the photosensitive drum 43 is transferred to a sheet. On the other hand, the toner image formed on the photosensitive drum 43 can be transferred to an intermediate transfer belt, and then transferred to a sheet from the intermediate transfer belt.

A transporting device 50 transports the sheet on which the toner image is transferred to a fixing device 51. The fixing device 51 fixes the toner image onto the sheet by heating the sheet. A paper discharge roller 52 moves the sheet from the fixing device 51 to a tray 53. The sheet discharged from the paper discharge roller 52 is stacked on the tray 53.

The image scanning apparatus 1 generates image data by scanning an image of a document. In the embodiment, the image scanning apparatus 1 is provided in the image forming apparatus 40 as a digital multiplexer. When the image scanning apparatus 1 is provided in the image forming apparatus as a digital copier, or when only the image scanning apparatus 1 constitutes a product, the embodiment can be applied.

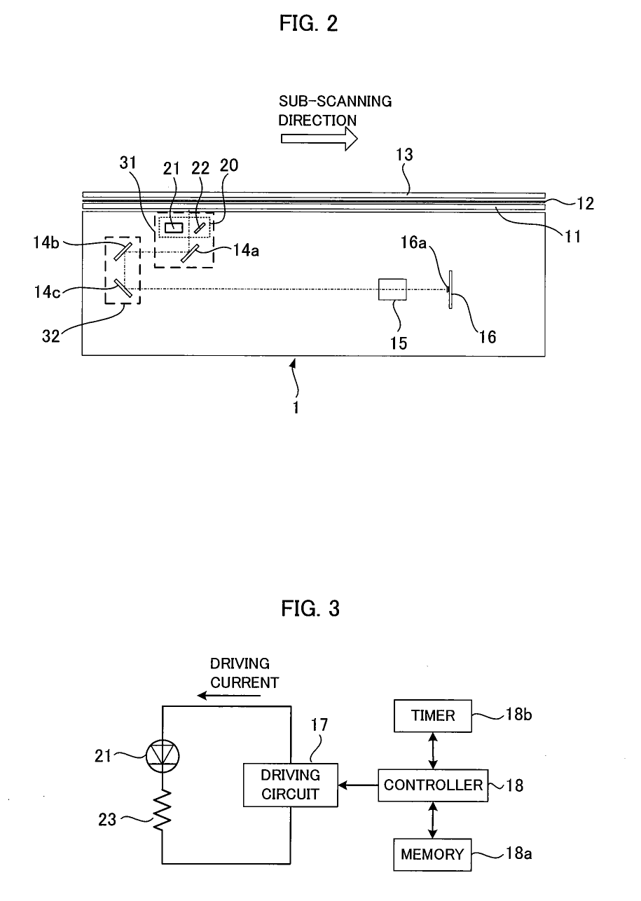

The configuration of the image scanning apparatus 1 will be described with reference to FIG. 2. FIG. 2 is a cross-sectional diagram of the image scanning apparatus 1 along the sub-scanning direction.

A document 12 is placed on a top surface of a platen glass 11, and a surface to be read of the document 12 faces the top surface of the platen glass 11. A platen cover 13 can be rotated with respect to a main body of the image scanning apparatus 1, and moves between a position to open the top surface of the platen glass 11 and a position to cover the top surface of the platen glass 11. The document 12 is held down to the platen glass 11 by moving the platen cover 13 to a covering position. The platen cover 13 can be provided in an ADF (Automatic Document Feeder). The ADF automatically transports documents to the image scanning apparatus 1.

An illuminating device 20 irradiates the document 12 with illumination light. The illuminating device 20 includes an LED (Light Emitting Diode) 21 and a reflector 22. The LED 21 can be provided singly or in plural. Light radiated from the LED 21 is reflected on the reflector 22 to reach the document 12.

The illuminating device 20 extends in a direction orthogonal to a paper surface of FIG. 2 (main scanning direction), and radiates linear illumination light extending in the main scanning direction. The linear illumination light reaches an image area by one line extending in the main scanning direction on the document 12.

Reflection light from the document 12 is reflected on return mirrors 14a, 14b, and 14c and goes toward an imaging lens 15. The imaging lens 15 condenses light from the return mirror 14c to form an image on an image sensor 16. The image sensor 16 includes a plurality of light sensing elements 16a arranged in a direction orthogonal to the paper surface of FIG. 2. The plurality of light sensing elements 16a are arranged corresponding to the linear illumination light so as to sense the linear illumination light.

Each of the light sensing elements 16a outputs electrical signals according to the intensity of incident light through photoelectric conversion. As the image sensor 16, for example, a CCD (Charge Coupled Device) sensor can be used.

The image area of one line extending in the main scanning direction on the document 12 can be read by causing the reflection light from the document 12 to be incident to the plurality of light sensing elements 16a.

A first carriage 31 supports the illuminating device 20 and the return mirror 14a, and moves in the sub-scanning direction. A second carriage 32 supports the return mirrors 14b and 14c, and moves in the sub-scanning direction.

The first carriage 31 and the second carriage 32 move in the sub-scanning direction relatively to each other, and maintain the length of an optical path consistently from a surface of the document 12 (reflection surface of the illumination light) to an image forming surface of the image sensor 16. The first carriage 31 and the second carriage 32 are synchronized with a time point when an image is read in the image sensor 16 (with a signal controlling an output of the image sensor 16), and move in the sub-scanning direction.

By moving the first carriage 31 and the second carriage 32, the illumination light from the illuminating device 20 can be scanned in the sub-scanning direction. While the first carriage 31 and the second carriage 32 move in the sub-scanning direction, the image area for one line extending in the main scanning direction on the document is sequentially read. By sequentially reading the image area for one line, it is possible to read the entire surface of the document 12.

FIG. 3 is a diagram showing a configuration of a circuit driving the illuminating device 20.

A driving circuit 17 receives a control signal from a controller 18 to cause driving currents to flow to the LED 21. The driving circuit 17 is connected to a power source, and receives electricity from the power source to drive the LED 21.

The LED 21 radiates light with light intensity according to driving currents. A resistor 23 is connected to the LED 21 in series.

The controller 18 is connected to a memory 18a, and determines the driving current of the LED 21 based on data stored in the memory 18a. When the driving current of the LED 21 is determined, the controller 18 drives the driving circuit 17 so as to cause the determined driving current to flow to the LED 21.

The controller 18 is connected to a timer 18b, and acquires time information counted by the timer 18b.

In the embodiment, the memory 18a and the timer 18b are provided outside the controller 18, but the memory 18a and the timer 18b may be installed in the controller 18.

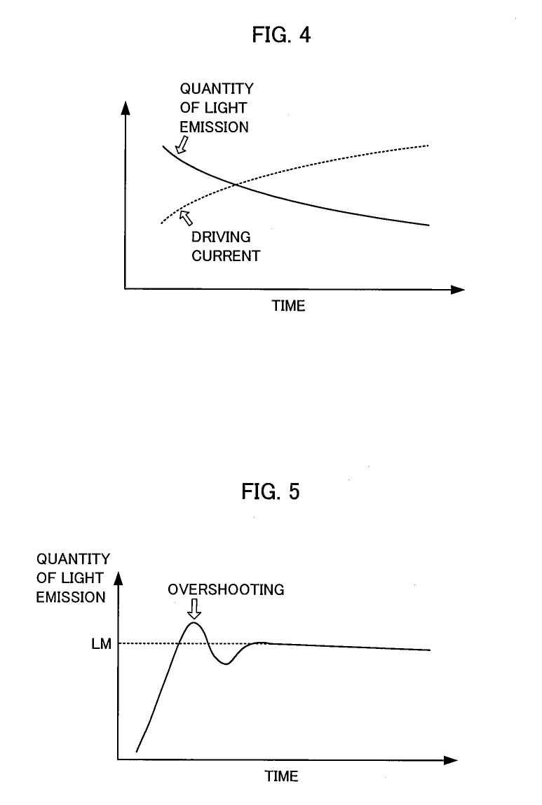

FIG. 4 shows changes of the quantity of light emission from the LED 21 and of the driving currents with time. In FIG. 4, a horizontal axis indicates time, and a vertical axis indicates the quantity of light emission or the driving currents.

The quantity of light emission from the LED 21 decreases with the passage of time. The quantity of light emission from the LED 21 shown in FIG. 4 shows a change when the LED 21 is driven with a constant driving current.

As the driving current of the LED 21 is raised, the quantity of light emission from the LED 21 can be heightened. Therefore, if the characteristic that the quantity of light emission from the LED 21 decreases is specified in advance, it is possible to determine a driving current according to the decrease in the quantity of light emission from the LED 21. In other words, the driving current of the LED 21 may be heightened by the amount of the decrease in the quantity of light emission from the LED 21.

A method (an example) of acquiring a light emission characteristic of the LED 21 will be described.

When the image scanning apparatus 1 is assembled, light of the LED 21 is radiated onto a reference plate, and light reflected on the reference plate is made to be incident to the image sensor 16. The reference plate is equivalent to the document 12 serving as reference. If the LED 21 continues to emit light, the quantity of light emission from the LED 21 decreases with the passage of time. As the quantity of light emission from the LED 21 decreases, the output of the image sensor 16 also changes.

The controller 18 can acquire information indicating the decrease in the quantity of light emission from the LED 21 based on the output of the image sensor 16. The controller 18 causes the memory 18a to save the acquired information. If the information indicating the decrease in the quantity of light emission from the LED 21 can be acquired, the driving current that can consistently maintain the quantity of light emission from the LED 21 can be determined.

In other words, the driving current of LED 21 may be raised by the amount of the decrease in the quantity of light emission from the LED 21. By determining the driving current of the LED 21 according to the decrease in the quantity of light emission from the LED 21, it is possible to determine control data of the driving current shown in FIG. 4.

The memory 18a stores the control data of the driving current shown in FIG. 4. The controller 18 controls the driving current of the LED 21 using the control data stored in the memory 18a.

The memory 18a can store the control data of the driving current shown in FIG. 4, and can store data indicating the light emission characteristic of the LED 21. When the memory 18a stores the data indicating the light emission characteristic of the LED 21, the controller 18 can determine the driving current of the LED 21 from the light emission characteristic of the LED 21 so as to consistently maintain the quantity of light emission from the LED 21.

A value for consistently maintaining the quantity of light emission from the LED 21 can be set to the quantity of light emission after driving of the LED 21 is started. FIG. 5 shows changes of the quantity of light emission when the LED 21 is driven. In FIG. 5, a horizontal axis indicates time, and a vertical axis indicates the quantity of light emission from the LED 21.

If driving of the LED 21 is started, the quantity of light emission from the LED 21 increases. The quantity of light emission from the LED 21 converges on a predetermined value after overshooting. Thus, it is possible to maintain the quantity of light emission from the LED 21 to a quantity of light emission LM after the convergence.

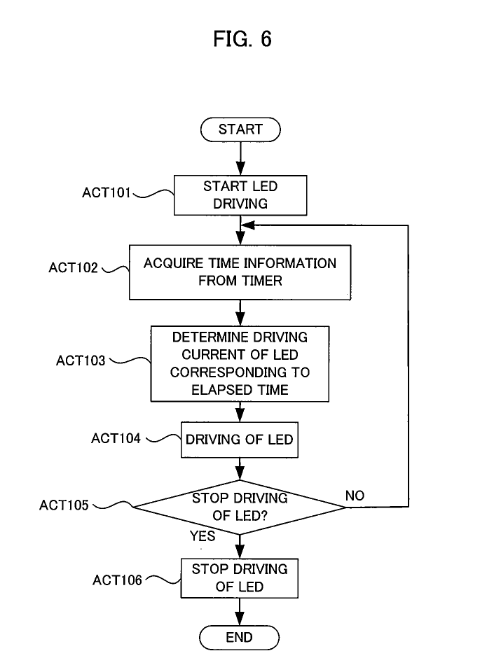

FIG. 6 shows a flowchart when driving of the LED 21 is controlled. The process shown in FIG. 6 is executed by the controller 18.

When the controller 18 controls the LED 21 to start driving (ACT 101), the controller 18 acquires time information from the timer 18b (ACT 102). A scanning operation of the image scanning apparatus 1 is performed after driving of the LED 21 is started and then a certain period of time passes. The quantity of light emission from the LED 21 shows the greatest change immediately after driving of the LED 21 is started, as illustrated in FIG. 5. Therefore, the scanning operation is to be performed after waiting until the change in the quantity of light emission from the LED 21 becomes moderate.

The controller 18 determines the driving current of the LED 21 based on the time information acquired in the process of ACT 102 (ACT 103). Specifically, the controller 18 specifies a driving current corresponding to the elapsed time using the control data stored in the memory 18a.

The controller 18 outputs a control signal to the driving circuit 17 so that the driving current determined in the process of ACT 103 flows into the LED 21 (ACT 104). The driving circuit 17 receives the control signal from the controller 18 and causes the driving current determined in the process of ACT 103 to flow into the LED 21 (ACT 104).

The controller 18 determines whether or not driving of the LED 21 is to be stopped (ACT 105). Specifically, the controller 18 determines whether or not the scanning operation of the image scanning apparatus 1 is to be ended. When driving of the LED 21 is not to be stopped (ACT 105, NO), the controller 18 performs the process of ACT 102 again. After the process of ACT 102 is performed, the controller 18 performs the processes of ACT 103, ACT 104, and ACT 105.

When driving of the LED 21 is to be stopped (ACT 105, YES), the controller 18 controls the LED 21 to stop driving by outputting the control signal to the driving circuit 17 (ACT 106).

On the other hand, it is possible to change the driving current of the LED 21 until a certain period of time passes after driving of the LED 21 is started as described using FIG. 6. After a light emission time of the LED 21 lasts for longer than a certain period of time, the driving current of the LED 21 can be set to a constant value.

After the light emission time of the LED 21 lasts for longer than the certain period of time, the illuminance of the document 12 is saturated by the LED 21. The certain period of time can be decided based on prior experiments. If the illuminance of the document 12 is saturated, the illuminance of the document 12 hardly changes even if the driving current of the LED 21 is fixed to a constant value. The constant value can be set to a value smaller than the driving current corresponding to the quantity of light emission LM shown in FIG. 5.

According to the embodiment, since the driving current of the LED 21 changes according to the light emission characteristic of the LED 21, it is possible to suppress a decrease in the quantity of light emission from the LED 21 with passage of time. In other words, the quantity of light emission from the LED 21 can be consistently maintained.

If the quantity of light emission from the LED 21 is consistently maintained, it is possible to suppress fluctuations in illuminance of light radiated on each document 12 when a plurality of pieces of the document 12 is scanned.

### Second Embodiment

In a second embodiment, points that differ from the first embodiment will be mainly described.

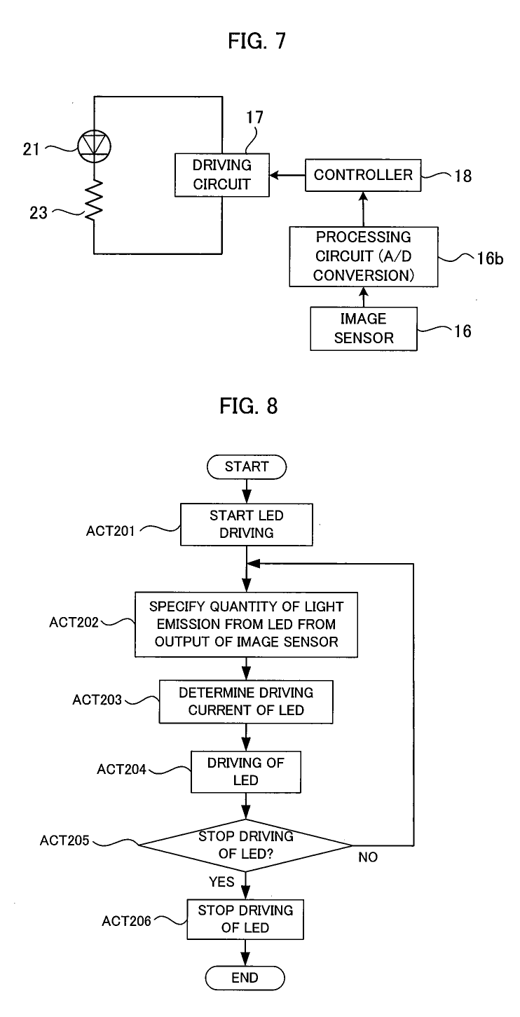

FIG. 7 is a diagram showing a configuration of a circuit driving the illuminating device 20 in the second embodiment.

An output signal of the image sensor 16 is input to a processing circuit 16b. The processing circuit 16b performs a predetermined process for the output signal of the image sensor 16, and outputs the processed signal to the controller 18. As the predetermined process, for example, there is an A/D conversion.

The image sensor 16 includes a first area used for reading images and a second area used for monitoring the quantity of light emission from the LED 21. The light sensing elements 16a are arranged in the first and the second areas. The second area is located at a different place from the first area.

A signal output from the first area of the image sensor 16 is used for generating an image corresponding to the document 12. A signal output from the second area of the image sensor 16 is input to the processing circuit 16b.

The controller 18 controls the driving circuit 17 according to an output signal of the processing circuit 16b. In other words, the controller 18 controls the driving current of the LED 21 based on the output of the image sensor 16.

FIG. 8 shows a flowchart when driving of the LED 21 is controlled. The process shown in FIG. 8 is executed by the controller 18.

The controller 18 starts driving the LED 21 (ACT 201). A scanning operation of the image scanning apparatus 1 is performed after driving of the LED 21 is started and a certain period of time passes. Light radiated from the LED 21 is reflected on the document 12 and led to the image sensor 16.

The controller 18 specifies the quantity of light emission from the LED 21, in other words, the illuminance of the document 12 irradiated with the light, based on the output of the image sensor 16 (ACT 202). If the LED 21 continues to emit light, the quantity of light emission from the LED 21 decreases with passage of time. Since the image sensor 16 outputs signals according to the quantity of light sensed, if the quantity of light emission from the LED 21 decreases, the output of the image sensor 16 also changes.

Therefore, the controller 18 can specify the quantity of light emission from the LED 21 based on the output of the image sensor 16. It is possible to prepare data indicating a correspondence relationship between the output of the image sensor 16 and the quantity of light emission from the LED 21 in advance. The controller 18 can specify the quantity of light emission from the LED 21 using the data indicating the correspondence relationship and the output of the image sensor 16.

The controller 18 determines a driving current of the LED 21 based on the quantity of light emission from the LED 21 specified in ACT 202 (ACT 203). If the quantity of light emission from the LED 21 does not decrease, the controller 18 controls the driving current of the LED 21 not to change. In other words, the driving current of the LED 21 stays in an initial value. If the quantity of light emission from the LED 21 decreases, the controller 18 controls the driving current of the LED 21 to be raised.

The controller 18 determines the quantity of change in the driving current of the LED 21 according to the quantity of decrease in the quantity of light emission from the LED 21. In other words, the controller 18 can raise the driving current of the LED 21 to the extent that the quantity of light emission from the LED 21 decreased. By elevating the driving current of the LED 21 according to decrease in the quantity of light emission from the LED 21, it is possible to consistently maintain the quantity of light emission from the LED 21, which is radiated on the document 12.

The controller 18 outputs a control signal to the driving circuit 17 so that the driving current determined in ACT 203 flows into the LED 21 (ACT 204). The driving circuit 17 receives the control signal from the controller 18, and causes the driving current determined in ACT 203 to flow into the LED 21 (ACT 204).

The controller 18 determines whether or not driving of the LED 21 is to be stopped (ACT 205). Specifically, the controller 18 determines whether or not the scanning operation of the image scanning apparatus 1 is to be ended. When driving of the LED 21 is not to be stopped (ACT 205, NO), the controller 18 performs the process of ACT 202 again. After performing the process of ACT 202, the controller 18 performs the processes of ACT 203, ACT 204, and ACT 205.

When driving of the LED 21 is to be stopped (ACT 205, YES), the controller 18 controls the LED 21 to stop driving by outputting the control signal to the driving circuit 17 (ACT 206).

According to the embodiment, the controller 18 can monitor the quantity of light emission from the LED 21 based on the output of the image sensor 16. The controller 18 can change the driving current of the LED 21 according to a monitoring result of the quantity of light emission from the LED 21. By changing the driving current of the LED 21 according to the quantity of light emission from the LED 21, it is possible to consistently maintain the quantity of light emission radiated on the document 12.

### Third Embodiment

In a third embodiment, points that differ from the first and second embodiments will be mainly described.

When the image scanning apparatus 1 generates color images in a scanning, an LED for R (red), an LED for G (green), and an LED for B (blue) are used as the LED 21.

When the LEDs 21 of R, G, and B are used, it is possible to perform the process described in the first embodiment (FIG. 6) for each of the LEDs 21. In other words, driving control for the LEDs 21 of R, G, and B can be individually performed.

By performing individual driving control for the LEDs 21 of R, G, and B, it is possible to secure the balance of colors of R, G, and B. The quantity of light emission from the LEDs 21 of R, G, and B can be determined in advance based on the balance of colors.

If the quantity of light emission from the LEDs 21 of R, G, and B is determined, the driving current of the LEDs 21 may be changed so as to maintain the determined quantity of light emission. If the characteristic indicating a decrease in the quantity of light emission from the LEDs 21 of R, G, and B is acquired in advance, it is possible to determine control data that changes the driving current of each of the LEDs 21.

In the first to third embodiments, the LED 21 provided in the image scanning apparatus 1 is described, but the embodiments can be applied to any equipment if the equipment includes an LED. It is possible to use a light source of which the quantity of light emission can be changed, instead of the LED.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light emitting device, comprising:
a light source which generates light and of which the quantity of light emission changes according to a driving current;
a driving circuit which runs the driving current to the light source to drive the light source; and
a controller which controls the driving circuit and raises the driving current of the light source as the quantity of light emission from the light source decreases.

2. The device according to claim 1, wherein the light source is an LED.

3. The device according to claim 1, further comprising:
a memory which stores data indicating a correspondence relationship between a light emission time of the light source and the driving current,
wherein the controller changes the driving current using the data stored in the memory.

4. The device according to claim 3, wherein the driving current increases as the light emission time becomes longer according to the data.

5. The device according to claim 1, further comprising:
a memory which stores data indicating a correspondence relationship between a light emission time and the quantity of light emission of the light source,
wherein the controller changes the driving current according to change in the quantity of light emission using the data stored in the memory.

6. The device according to claim 5, wherein the quantity of light emission decreases as the light emission time becomes longer according to the data.

7. The device according to claim 1, wherein the controller changes the driving current so that the quantity of light emission from the light source maintains a convergence value after overshooting.

8. The device according to claim 1, wherein the controller fixes the driving current to a predetermined value after driving of the light source is started and then a certain period of time passes.

9. The device according to claim 8, wherein the predetermined value is smaller than the driving current when driving of the light source is started.

10. The device according to claim 1, further comprising:
light sensing elements which sense light radiated from the light source,
wherein the controller specifies the quantity of light emission from the light source using outputs of the light sensing elements.

11. An image scanning apparatus, comprising:
a light source which generates light to be radiated on a document and of which the quantity of light emission changes according to a driving current;
light sensing elements which sense light reflected on the document and output a signal corresponding to the document;
a driving circuit which runs the driving current to the light source to drive the light source; and
a controller which controls the driving circuit and raises the driving current of the light source as the quantity of light emission from the light source decreases.

12. The apparatus according to claim 11, wherein the light source is an LED.

13. The apparatus according to claim 11, further comprising:
a memory which stores data indicating a correspondence relationship between a light emission time of the light source and the driving current,
wherein the controller changes the driving current using the data stored in the memory.

14. The apparatus according to claim 11, further comprising:
a memory which stores data indicating a correspondence relationship between a light emission time and the quantity of light emission of the light source
wherein the controller changes the driving current according to change in the quantity of light emission using the data stored in the memory.

15. The apparatus according to claim 11, wherein the controller changes the driving current so that the quantity of light emission from the light source maintains a convergence value after overshooting.

16. The apparatus according to claim 11, wherein the controller fixes the driving current to a predetermined value after driving of the light source is started and then a certain period of time passes.

17. The apparatus according to claim 16, wherein the predetermined value is smaller than the driving current when driving of the light source is started.

18. The apparatus according to claim 11, wherein the controller specifies the quantity of light emission from the light source using outputs of the light sensing elements.

19. The apparatus according to claim 11,
wherein there is a plurality of the light sources, and
the controller controls the quantity of light emission from each of the light sources individually through the driving circuit.

20. A control method of a light emitting device, comprising:
driving a light source by causing a driving current to flow into the light source of which the quantity of light emission changes according to the driving current; and
raising the driving current of the light source as the quantity of light emission from the light source decreases.
